(19) United States
(12) Patent Application Publication
(10) Pub. No.: US 2026/0163250 A1
(43) Pub. Date: Jun. 11, 2026

(54) Antenna Element, Antenna, and Communication Device

(71) Applicant: HUAWEI TECHNOLOGIES CO., LTD., Shenzhen (CN)

(72) Inventors: Lijun Pan, Dongguan (CN); Wenhui Deng, Dongguan (CN); Weihong Xiao, Dongguan (CN); Xiaogang Xue, Dongguan (CN); Jianrong Li, Shenzhen (CN)

(73) Assignee: HUAWEI TECHNOLOGIES CO., LTD., Shenzhen (CN)

(21) Appl. No.: 19/465,319

(22) Filed: Jan. 30, 2026

Related U.S. Application Data
(63) Continuation of application No. PCT/CN2024/108585, filed on Jul. 30, 2024.

(30) Foreign Application Priority Data
Jul. 31, 2023 (CN) 202310961619.8

(51) Int. Cl. H01Q 15/24; H01Q 1/24; H01Q 9/44

(52) U.S. Cl. CPC H01Q 15/24; H01Q 1/246; H01Q 9/44

(57) ABSTRACT

Embodiments of this application provide an antenna element which includes four radiators and four feed structures. The feed structure is connected to the radiator, and is configured to feed the radiator. The radiator includes a first transmission line, a first radiation arm, a second radiation arm, and a second transmission line that are sequentially connected, where the first transmission line and the second transmission line are respectively connected to the feed structures. The four radiators are respectively a first radiator, a second radiator, a third radiator, and a fourth radiator, where the first radiator and the second radiator radiate signals in a first polarization direction, and the third radiator and the fourth radiator radiate signals in a second polarization direction, to form a dual-polarized antenna element. The feed structure is a one-to-two feed structure, and two radiators are connected in parallel and connected to a same feed structure.

### CROSS-REFERENCE TO RELATED APPLICATIONS

This application is a continuation of International Application No. PCT/CN2024/108585, filed on Jul. 30, 2024, which claims priority to Chinese Patent Application No. 202310961619.8, filed on Jul. 31, 2023. The disclosures of the aforementioned applications are hereby incorporated by reference in their entireties.

### TECHNICAL FIELD

This application relates to the field of communication technologies, and in particular, to an antenna element, an antenna, and a communication device.

### BACKGROUND

With development of wireless communication technologies, signals transmitted by a communication system are increasingly diverse, leading to more complex requirements for a base station antenna. The base station antenna generally includes an antenna element and a feed network, and the feed network is configured to feed the antenna element.

A structure of the base station antenna is increasingly complex, and antenna integration of a single antenna installation platform is increasingly high. To improve base station antenna integration, a requirement for miniaturization of the base station antenna is increasingly urgent, especially for an aperture size of the antenna. To improve antenna integration, the aperture of the antenna needs to be reduced. However, reduction of the aperture of the antenna is likely to cause a problem of a reduced gain of the antenna.

### SUMMARY

Embodiments of this application provide an antenna element, an antenna, and a communication device. The antenna has a high gain, a small aperture, and a wide bandwidth.

According to a first aspect, this application provides an antenna element. The antenna element includes four radiators and four feed structures. The feed structure is connected to the radiator, and the feed structure is configured to connect to a feed network, so that the feed structure is configured to feed the radiator. The radiator includes a first transmission line, a first radiation arm, a second radiation arm, and a second transmission line that are sequentially connected, where the first transmission line and the second transmission line are respectively connected to the feed structures. The four lines of the radiator may specifically form a quadrilateral with an opening, and the opening is located between the first transmission line and the second transmission line. A structure of the radiator in this solution is simple. For ease of description, it is considered that the four radiators are respectively a first radiator, a second radiator, a third radiator, and a fourth radiator. The first radiator and the second radiator radiate signals in a first polarization direction, and the third radiator and the fourth radiator radiate signals in a second polarization direction, to form a dual-polarized antenna element. Specifically, the first polarization direction intersects with the second polarization direction.

The feed structure is a one-to-two feed structure. Specifically, the feed structure may include a power splitter, to form the one-to-two feed structure. One feed structure is connected to transmission lines that are respectively connected to two radiators. For ease of description, it is considered that the feed structure includes a first feed structure, a second feed structure, a third feed structure, and a fourth feed structure. Specifically, when the radiators are connected to the feed structures, the first transmission line of the first radiator and the first transmission line of the second radiator are connected in parallel and connected to the first feed structure, the second transmission line of the first radiator and the second transmission line of the second radiator are connected in parallel and connected to the second feed structure, the first transmission line of the third radiator and the first transmission line of the fourth radiator are connected in parallel and connected to the third feed structure, and the second transmission line of the third radiator and the second transmission line of the fourth radiator are connected in parallel and connected to the fourth feed structure. In this solution, the antenna element is a dual-polarized antenna element, and a structure of the feed structure is simple. One feed structure is used to feed two radiators. This helps further reduce an aperture of the antenna and improve a gain of the antenna. It may be understood that, in a case of a same gain, the aperture of the antenna is smaller; and in a case of a same aperture, the gain of the antenna in embodiments provided in this application is larger.

In addition, the radiator in the technical solution of this application is fed from the first transmission line and the second transmission line that are located at two ends, to form an end-fed dipole. In addition to being used to connect to the feed structure and feed the radiator, the first transmission line and the second transmission line are also used as radiation arms to radiate signals. When the antenna operates in different frequency bands, corresponding operating states are different, and different current distribution forms are formed, so that the antenna can have a wide bandwidth.

Specifically, when the antenna element is disposed, the four radiators may be arranged into a 2*2 matrix structure, the first radiator and the third radiator are arranged into one row, and the fourth radiator and the second radiator are arranged into another row. The first radiator and the second radiator are arranged along a diagonal, and the third radiator and the fourth radiator are arranged along another diagonal.

In a possible technical solution, a length of the first transmission line of the first radiator is not equal to a length of the first transmission line of the second radiator, and a length of the first transmission line of the third radiator is not equal to a length of the first transmission line of the fourth radiator. Lengths of two transmission lines that are connected in parallel and that are connected to a same feed structure are different, which allows the radiator to introduce a preset phase, and a beam of the radiator deflects to one side of a transmission line with a longer length, to adapt to a beam deflection requirement in a harsh reflection panel environment. In this solution, a length of a transmission line of a radiator may be designed based on the beam deflection requirement. An adjustment manner is simple, and better horizontal beam deflection advantages can be achieved in an asymmetric environment. Compared with a single dipole, the technical solution of this application has a more significant preset phase effect.

The first polarization direction and the second polarization direction may be specifically perpendicular to each other, that is, the two polarization directions of the antenna are perpendicular to each other. For example, the two polarization directions may be +45° and −45° respectively.

A shape formed by the four lines of the radiator is not limited. For example, in a possible technical solution, the radiator is a rectangle. Specifically, the first transmission line of the radiator is perpendicular to the first radiation arm, the first radiation arm is perpendicular to the second radiation arm, and the second radiation arm is perpendicular to the second transmission line. The radiator in this solution has a simple structure, and is beneficial to forming a precise radiation direction and polarization direction. A structure of the radiator is regular, which is beneficial to reducing space occupied by the radiator and reducing the aperture of the antenna. In another technical solution, the radiator may alternatively be in a shape such as a rhombus, a trapezoid, or an irregular quadrilateral.

The feed structure specifically includes a feeder. The feeder may be connected to a one-to-two power splitter, so that one feeder may be connected to two transmission lines, and current directions of the two transmission lines are opposite. The first transmission line of the radiator includes a first connection part and a second connection part connected to each other, the second connection part is connected to the feeder, and a cross-sectional area of the second connection part is different from a cross-sectional area of the feeder connected to the second connection part. The second transmission line of the radiator includes a third connection part and a fourth connection part connected to each other, the fourth connection part is connected to the feeder, and a cross-sectional area of the fourth connection part is different from a cross-sectional area of the feeder connected to the fourth connection part. In this solution, the first transmission line and the second transmission line are separately used as a part of a feed path, so that the transmission lines in the feed path have changes in thickness, and impedance matching may be performed, to improve the bandwidth. In addition, the transmission line (the second connection part and the fourth connection part) connected to the feeder is thick, which can increase inductance and enable a resonance point of the radiator to move toward a high frequency.

Further, the cross-sectional area of the second connection part may be different from a cross-sectional area of the first connection part, and the cross-sectional area of the fourth connection part may be different from a cross-sectional area of the third connection part. Similarly, the first connection part and the second connection part of the first transmission line may also be considered as a part of the feed path, and the third connection part and the fourth connection part of the second transmission line may also be considered as a part of the feed path. This also means that the transmission lines in the feed path have changes in thickness and changes are diverse and rich, which is beneficial for impedance matching and bandwidth improvement.

When the radiator is formed, a cross-sectional area of the first radiation arm is different from a cross-sectional area of the second radiation arm. Different radiation arms of the radiator have changes in thickness, which is also beneficial for impedance matching and bandwidth improvement.

To improve communication device integration, the antenna may be a multi-band antenna. To reduce impact of a low-frequency antenna on a high-frequency antenna, the low-frequency antenna needs to have a high-frequency decoupling effect. The first radiation arm, the second radiation arm, the first transmission line, and the second transmission line of the radiator in the technical solution of this application each are connected to a stub. When the stubs are specifically disposed, the stubs of the first radiator and the second radiator are symmetrically arranged with respect to the first polarization direction, and the stubs of the third radiator and the fourth radiator are symmetrically arranged with respect to the second polarization direction, so that the polarization directions of the radiators are stable and accurate. The disposition of the stubs may reduce impact of the antenna element on an antenna element in a higher frequency band, which is beneficial to implementing multi-band collaborative working of the antenna and reducing the aperture occupied by the antenna.

In a specific technical solution, shapes of the stubs may include at least one of an L-shaped stub, a cross-shaped stub, or a ±-shaped stub, which is specifically designed according to requirements.

Alternatively, an additional stub may be disposed inside the radiator, and the additional stub is not directly connected to the radiator. When the additional stub is specifically disposed, the additional stubs of the first radiator and the second radiator are symmetric in the first direction, and the additional stubs of the third radiator and the fourth radiator are symmetric in the second direction. This disposition solution facilitates polarization directions of the radiators to be stable and accurate. The disposition of the additional stubs may also reduce impact of the antenna element on an antenna element in a higher frequency band, which is beneficial to implementing multi-band cooperative work of the antenna and reducing the aperture occupied by the antenna.

A shape of the additional stub may be specifically symmetric, or the additional stub is a symmetric stub. Therefore, the polarization directions of the antenna element are stable and accurate.

Specifically, when the antenna element is formed, the feed structure and the antenna element may be formed on a same dielectric plate. In specific implementation, two radiators in one polarization direction may be located at one layer of the dielectric plate, and two radiators in the other polarization direction may be located at the other layer of the dielectric plate. This solution is beneficial to reducing a size of the antenna and improving an integration level of the antenna.

According to a second aspect, this application further provides an antenna, where the antenna includes a feed network and a plurality of antenna elements provided in the first aspect, and the feed structure of the antenna elements is connected to the feed network. The antenna is a dual-polarized antenna, and the antenna has a large gain, a small aperture, and a wide bandwidth.

According to a third aspect, this application further provides a communication device, where the communication device includes the antenna provided in the first aspect, and further includes a mounting bracket and a radio frequency apparatus. The antenna is mounted on the mounting bracket, and the feed structure of the antenna is electrically connected to the radio frequency apparatus. The antenna in this solution has a large gain, a small aperture, and a wide bandwidth.

### BRIEF DESCRIPTION OF DRAWINGS

FIG. 1 is a diagram of an architecture of a communication system to which an embodiment of this application is applicable;

FIG. 2 is a diagram of a structure of a base station according to an embodiment of this application;

FIG. 3 is a diagram of a composition of an antenna according to an embodiment of this application;

FIG. 4 is a diagram of a structure of an antenna element according to an embodiment of this application;

FIG. 5 is a diagram of current flows of a first radiator and a second radiator of an antenna element according to an embodiment of this application;

FIG. 6 is another diagram of current flows of a first radiator and a second radiator of an antenna element according to an embodiment of this application;

FIG. 7 is another diagram of a structure of an antenna element of an antenna according to an embodiment of this application;

FIG. 8 is another diagram of a structure of an antenna element according to an embodiment of this application;

FIG. 9 is a diagram of feeding of an antenna element according to an embodiment of this application; and

FIG. 10 is another diagram of feeding of an antenna element according to an embodiment of this application.

Reference Numerals:

| | |
|---|---|
| 1-Antenna; | 11-Radome; |
| 12-Antenna element; | 121-Radiator; |
| 1211-First transmission line; | 12111-First connection part; |
| 12112-Second connection part; | 1212-First radiation arm; |
| 1213-Second radiation arm; | 1214-Second transmission line; |
| 12141-Third connection part; | 12142-Fourth connection part; |
| 122-Stub; | 123-Additional stub; |
| 13-Feed network; | 131-Feed structure; |
| 1311-Feeder; | 14-Dielectric plate; |
| 141-Conductive via; | 15-Balun; |
| 2-Mounting bracket; | 3-Antenna adjustment support; |
| 4-Radio frequency processing unit; | 5-Baseband processing unit; |
| 6-Cable; | X-First polarization direction; |
| Y-Second polarization direction. | |

### DESCRIPTION OF EMBODIMENTS

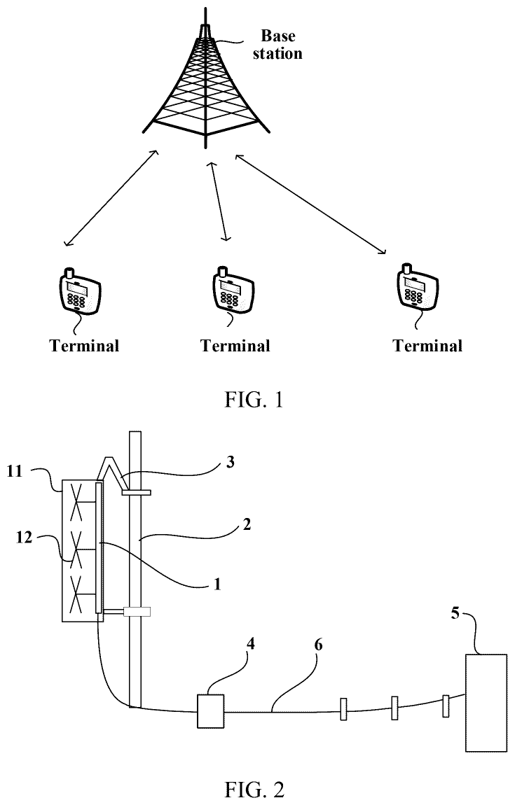

To facilitate understanding of an antenna element, an antenna, and a communication system provided in embodiments of this application, the following describes an application scenario of the antenna element, the antenna, and the communication system. FIG. 1 shows an example of a diagram of an architecture of a communication system to which an embodiment of this application is applicable. As shown in FIG. 1, the communication system may be a base station antenna feeder system. The application scenario may include a base station and a terminal. Wireless communication may be implemented between the base station and the terminal. The base station may be located in a base station subsystem (base station subsystem, BSS), a UMTS terrestrial radio access network (UMTS terrestrial radio access network, UTRAN), or an evolved universal terrestrial radio access network (evolved universal terrestrial radio access network, E-UTRAN), and is configured to perform cell coverage of a radio signal, to implement communication between a terminal device and a wireless network. Specifically, the base station may be a base transceiver station (base transceiver station, BTS) in a global system for mobile communication (global system for mobile communication, GSM) or a code division multiple access (code division multiple access, CDMA) system, or may be a NodeB (NodeB, NB) in a wideband code division multiple access (wideband code division multiple access, WCDMA) system, or may be an evolutional NodeB (evolutional NodeB, eNB, or eNodeB) in a long term evolution (long term evolution, LTE) system, or may be a radio controller in a cloud radio access network (cloud radio access network, CRAN) scenario. Alternatively, the base station may be a relay station, an access point, a vehicle-mounted device, a wearable device, a gNodeB (gNodeB or gNB) in a new radio (new radio, NR) system, a base station in a future evolved network, or the like. This is not limited in embodiments of this application.

FIG. 2 is a diagram of a possible structure of a base station according to an embodiment of this application. The base station may usually include structures such as an antenna 1, a mounting bracket 2, and an antenna adjustment support 3. The antenna 1 may be mounted on the mounting bracket 2 by using the antenna adjustment support 3, to facilitate signal receiving or transmitting of the antenna 1. Certainly, an embodiment shown in FIG. 2 is merely used as an optional implementation. During specific implementation, the antenna and the base station in this embodiment of this application may be different from those in the embodiment shown in FIG. 2. This is not limited in this application.

The antenna 1 of the base station includes a radome 11. The radome 11 has a good electromagnetic wave penetration characteristic in terms of electrical properties, and can withstand impact of an external harsh environment in terms of mechanical performance, so that the antenna 1 can be protected from the impact of the external environment. The antenna 1 may be mounted on a pole 2 or a tower by using the antenna adjustment support 3, to facilitate signal receiving or transmitting of the antenna 1.

In addition, the base station may further include a radio frequency processing unit 4 and a baseband processing unit 5. For example, the radio frequency processing unit 4 may be configured to perform frequency selection, amplification, and down-conversion processing on signals received by the antenna 1, convert the signals into intermediate frequency signals or baseband signals, and send the intermediate frequency signals or the baseband signals to the baseband processing unit 5; or the radio frequency processing unit 4 is configured to perform up-conversion and amplification on the baseband processing unit 5 or intermediate frequency signals, and convert, by using the antenna 1, the baseband processing unit 5 or the intermediate frequency signals into electromagnetic waves and sends the electromagnetic waves out. The baseband processing unit 5 may be connected to a feed network 13 of the antenna 1 by using the radio frequency processing unit 4. In some implementations, the radio frequency processing unit 4 may also be referred to as a remote radio unit (remote radio unit, RRU), or may be a radio frequency module in an active antenna unit (Active Antenna Unit, AAU), and the baseband processing unit 5 may also be referred to as a baseband unit (baseband unit, BBU).

In a possible embodiment, as shown in FIG. 2, the radio frequency processing unit 4 and the antenna 1 may be integrally disposed, and the baseband processing unit 5 is located at a remote end of the antenna 1. In some other embodiments, the radio frequency processing unit 4 and the baseband processing unit 5 may be alternatively both located at the remote end of the antenna 1. The radio frequency processing unit 4 and the baseband processing unit 5 may be connected through a cable 6.

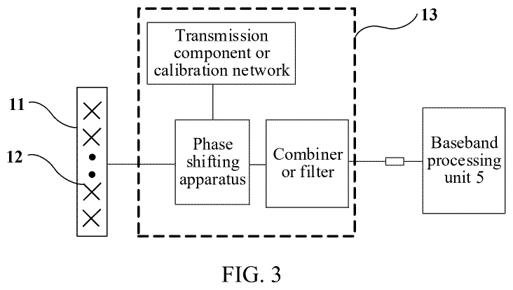

FIG. 3 is a diagram of a possible composition of an antenna according to an embodiment of this application. As shown in FIG. 2 and FIG. 3, the antenna 1 includes a plurality of antenna elements 12 and a feed network 13. The antenna element 12 may also be referred to as a radiation unit, an element, or the like, and can effectively send or receive an antenna signal. In the antenna 1, frequencies of different antenna elements 12 may be the same or different. The antenna elements 12 are connected to the feed network 13, and the feed network 13 is configured to feed the antenna elements 12. Specifically, the feed network 13 is usually formed by controlled impedance transmission lines. The feed network 13 may feed signals to the antenna element 12 at a specific amplitude and a specific phase, or send signals received by the antenna element 12 to the baseband processing unit 5 of the base station at a specific amplitude and a specific phase. Specifically, in some implementations, the feed network 13 may be configured to implement different beam radiation directions, or may be connected to a calibration network to obtain a calibration signal required by a system. Some modules configured to expand performance may be further disposed in the feed network 13. For example, a combiner may be configured to combine signals of different frequencies into one path of signals, and transmit the signals by using the antenna element 12; or when being used in a reverse direction, the combiner may be configured to split, based on different frequencies, signals received by the antenna element 12 into a plurality of paths of signals, and transmit the signals to the baseband processing unit for processing. For another example, a filter is configured to filter out an interference signal. In a specific embodiment, the plurality of antenna elements 12 may form an antenna element array, and work in a form of an array.

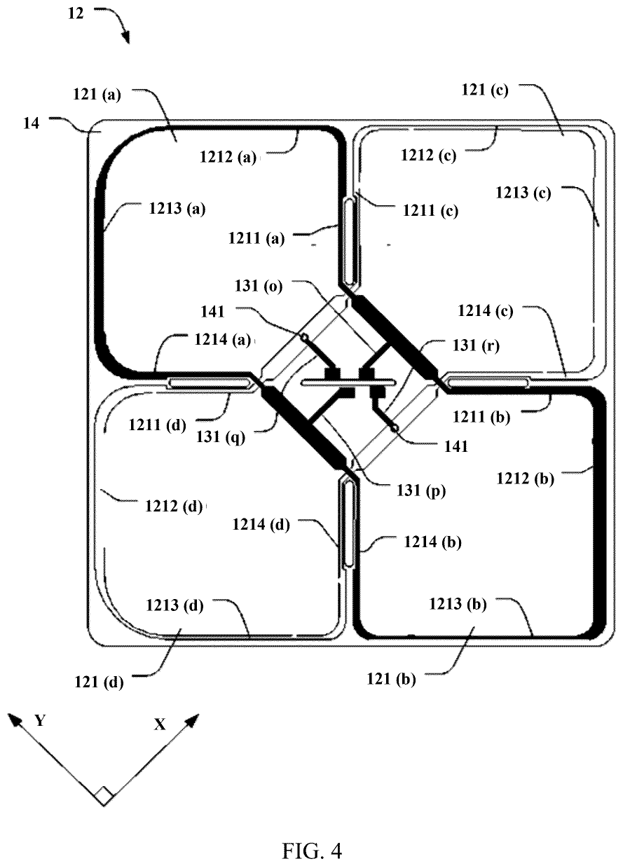

FIG. 4 is a diagram of a structure of an antenna element according to an embodiment of this application. The antenna in embodiments of this application includes a plurality of antenna elements 12 shown in FIG. 4. The antenna element 12 includes four radiators 121 and four feed structures 131. The radiator 121 includes a first transmission line 1211, a first radiation arm 1212, a second radiation arm 1213, and a second transmission line 1214 that are sequentially connected. The first transmission line 1211 and the second transmission line 1214 of the radiator 121 are separately connected to the feed network 13, to feed the first radiation arm 1212 and the second radiation arm 1213. In a specific embodiment, the first transmission line 1211, the first radiation arm 1212, the second radiation arm 1213, and the second transmission line 1214 may be an integrally formed linear structure.

For the descriptions of the radiator in specific embodiments of this application, each radiator of the antenna element may satisfy the descriptions, or at least one radiator of the antenna element may satisfy the descriptions. Structures of different radiators of the antenna element may be the same, similar, or different. For example, each radiator 121 may include the first transmission line 1211, the first radiation arm 1212, the second radiation arm 1213, and the second transmission line 1214 that are sequentially connected. The first transmission line 1211 and the second transmission line 1214 of the radiator 121 are separately connected to the feed network 13, to feed the first radiation arm 1212 and the second radiation arm 1213. Similarly, for the descriptions of the feed structure in specific embodiments of this application, each feed structure of the antenna element may satisfy the descriptions, or at least one feed structure of the antenna element may satisfy the descriptions.

As shown in FIG. 4, the antenna element 12 in this embodiment of this application includes four radiators 121. For ease of description, it is considered that the four radiators 121 are respectively a first radiator 121(a), a second radiator 121(b), a third radiator 121(c), and a fourth radiator 121(d), and the first radiator 121(a) and the second radiator 121(b) radiate signals in a first polarization direction. The third radiator 121(c) and the fourth radiator 121(d) radiate signals in a second polarization direction, to form a dual-polarized antenna element 12. The first polarization direction X intersects with the second polarization direction Y.

Still refer to FIG. 4. The feed structure 131 of the antenna provided in this embodiment of this application is connected to the feed network 13 and the radiator 121, and is configured to feed the radiator 121. For one antenna element 12, corresponding feed structures 131 include a first feed structure 131(o), a second feed structure 131(p), a third feed structure 131(q), and a fourth feed structure 131(r). The feed structure 131 includes a power splitter, so that the feed structure 131 is a one-to-two feed structure, and one feed structure 131 may be connected to two radiators 121. Currents of two transmission lines connected to a same one-to-two feed structure are parallel and in a same phase. Specifically, if a first transmission line 1211(a) of the first radiator 121(a) and a first transmission line 1211(b) of the second radiator 121(b) are connected in parallel and connected to the first feed structure 131(o), current directions of the first transmission line 1211(a) of the first radiator 121(a) and the first transmission line 1211(b) of the second radiator 121(b) are opposite; if a second transmission line 1214(a) of the first radiator 121(a) and a second transmission line 1214(b) of the second radiator 121(b) are connected in parallel and connected to the second feed structure 131(p), current directions of the second transmission line 1214(a) of the first radiator 121(a) and the second transmission line 1214(b) of the second radiator 121(b) are opposite; if a first transmission line 1211(c) of the third radiator 121(c) and a first transmission line 1211(d) of the fourth radiator 121(d) are connected in parallel and connected to the third feed structure 131(q), current directions of the first transmission line 1211(c) of the third radiator 121(c) and the first transmission line 1211(d) of the fourth radiator 121(d) are opposite; and if a second transmission line 1214(c) of the third radiator 121(c) and a second transmission line 1214(d) of the fourth radiator 121(d) are connected in parallel and connected to the fourth feed structure 131(r), current directions of the second transmission line 1214(c) of the third radiator 121(c) and the second transmission line 1214(d) of the fourth radiator 121(d) are opposite. In this solution, a structure of the feed structure 131 is simple, which is further beneficial to reducing an aperture of the antenna and improving a gain of the antenna. It may be understood that, in a case of a same gain, the aperture of the antenna provided in embodiments of this application is smaller; and in a case of a same aperture, the gain of the antenna provided in embodiments of this application is larger.

Unless otherwise specified, the “connection” in embodiments of this application may refer to a direct physical connection relationship, indicating that the two are in a contact relationship; or may refer to a connection performed in a coupling manner, indicating that the two are not in a contact relationship.

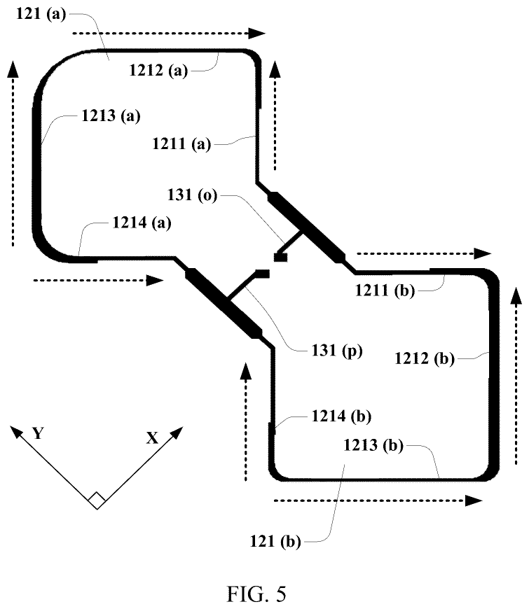

The radiator 121 in embodiments of this application is fed from the first transmission line 1211 and the second transmission line 1214 that are located at two ends, to form an end-fed dipole. In addition to being used to connect to the feed structure 131 and feed the radiator 121, the first transmission line 1211 and the second transmission line 1214 are also used as radiation arms to radiate signals. When the antenna operates in different frequency bands, corresponding operating states are different. For example, FIG. 5 is a diagram of current flows of a first radiator and a second radiator of an antenna element according to an embodiment of this application. Dashed lines in the figure represent flow directions of currents. As shown in FIG. 5, when operating in a first operating frequency band, the antenna operates in a first operating state. In the first operating state, the first radiator 121(a) and the second radiator 121(b) are configured to implement signal radiation in one polarization direction of the antenna element 12. For the first radiator 121(a), a current direction of the first transmission line 1211(a) is opposite to a current direction of the first radiation arm 1212(a), and a zero point of a current is formed at an intersection point of the first transmission line 1211(a) and the first radiation arm 1212(a); the current direction of the first radiation arm 1212(a) is the same as a current direction of the second radiation arm 1213(a); a current direction of the second transmission line 1214(a) is opposite to the current direction of the second radiation arm 1213(a), and a zero point of a current is formed at an intersection point of the second transmission line 1214(a) and the second radiation arm 1213(a); and the current direction of the first transmission line 1211(a) is the same as the current direction of the second transmission line 1214(a). The first radiation arm 1212(a) and the second radiation arm 1213(a) of the first radiator 121(a) operate collaboratively to form a one-element array, and the first transmission line 1211(a) and the second transmission line 1214(a) operate collaboratively to form a one-element array. Similarly, if the first radiation arm 1212(b) and the second radiation arm 1213(b) of the second radiator 121(b) operate collaboratively to form a one-element array, and the first transmission line 1211(a) and the second transmission line 1214(a) operate collaboratively to form a one-element array, a four-element array is formed in one polarization direction of the antenna element 12. Correspondingly, the third radiator 121(c) and the fourth radiator 121(d) may also form a four-element array, that is, a four-element array may also be formed in the other polarization direction of the antenna element 12. The antenna in this solution can obtain a good gain in a case of a small aperture.

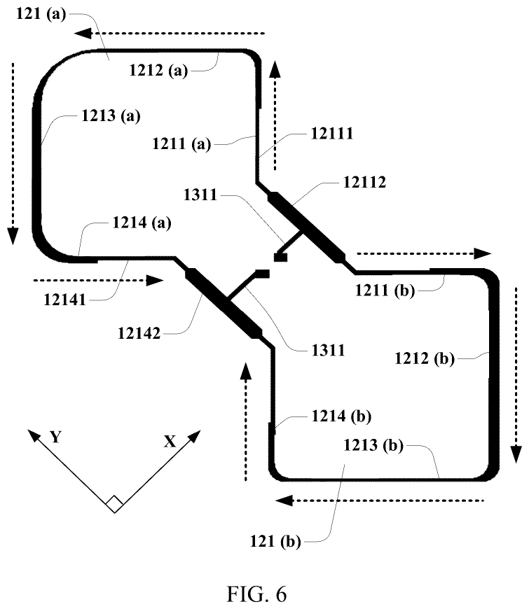

FIG. 6 is another diagram of current flows of a first radiator and a second radiator of an antenna element according to an embodiment of this application. As shown in FIG. 6, when operating in a second operating frequency band, the antenna operates in a second operating state. In the second operating state, the first radiator 121(a) and the second radiator 121(b) are configured to implement signal radiation in one polarization direction of the antenna element 12, and directions of currents generated by the first transmission line 1211, the first radiation arm 1212, the second radiation arm 1213, and the second transmission line 1214 are the same. In this way, the first radiator 121(a) and the second radiator 121(b) each form a ring current, and the third radiator 121(c) and the fourth radiator 121(d) each also form a ring current.

In the technical solution of this application, the antenna can operate in different operating frequency bands, which can increase a bandwidth of the antenna.

In a specific embodiment, the first operating frequency band may be higher than the second operating frequency band. For example, the first operating frequency band may be 700 MHz to 900 MHz, and the second operating frequency band may be 600 MHz to 700 MHz. In this case, the bandwidth of the antenna may be 600 MHz to 900 MHz, and the bandwidth is wide.

In the technical solution of this application, the first transmission line 1211, the first radiation arm 1212, the second radiation arm 1213, and the second transmission line 1214 of the radiator 121 that are sequentially connected form a quadrilateral. In a specific embodiment, adjacent lines of the first transmission line 1211, the first radiation arm 1212, the second radiation arm 1213, and the second transmission line 1214 are perpendicular. Specifically, the first transmission line 1211 is perpendicular to the first radiation arm 1212, the first radiation arm 1212 is perpendicular to the second radiation arm 1213, and the second radiation arm 1213 is perpendicular to the second transmission line 1214, so that the radiator 121 is approximately rectangular or square. In specific implementation, a circular arc transition instead of an absolute right-angle transition may be used between two adjacent lines. In another embodiment, the first transmission line 1211, the first radiation arm 1212, the second radiation arm 1213, and the second transmission line 1214 form a shape such as a rhombus or the like.

Still refer to FIG. 4. In a specific embodiment, the first polarization direction X is perpendicular to the second polarization direction Y. Specifically, the first polarization direction X may be a 45° direction, and the second polarization direction Y may be a −45° direction. In this embodiment, the four radiators 121 may be arranged in an array, the first radiator 121(a) and the third radiator 121(c) are arranged in one row, the fourth radiator 121(d) and the second radiator 121(b) are arranged in the other row, the first radiator 121(a) and the fourth radiator 121(d) are arranged in one column, and the third radiator 121(c) and the second radiator 121(b) are arranged in the other column. Further, the first radiator 121(a) and the second radiator 121(b) are arranged diagonally, and the third radiator 121(c) and the fourth radiator 121(d) are arranged diagonally.

Still refer to FIG. 4 to FIG. 6. During specific implementation of the foregoing embodiments, the feed structure 131 may include a feeder 1311, and each feeder is connected to transmission lines of two radiators 121, to achieve a one-to-two feed structure 131. Radiators 121 connected to the same feeder 1311 are connected in parallel. The first transmission line 1211 and the second transmission line 1214 of the radiator 121 are respectively connected to the feeders 1311, the first transmission line 1211 includes a first connection part 12111 and a second connection part 12112 connected to each other, the second connection part 12112 is connected to the feeder 1311, and the first connection part 12111 is connected to the first radiation arm 1212. Similarly, the second transmission line 1214 includes a third connection part 12141 and a fourth connection part 12142 connected to each other, the fourth connection part 12142 is connected to the feeder 1311, and the third connection part 12141 is connected to the second radiation arm 1213.

In a specific embodiment, the feeder 1311 may be a coaxial inner-outer conductor structure. The feeder 1311 may be connected between two radiators 121. In other words, two radiators 121 connected to the same feeder 1311 are symmetrically disposed with respect to a connection point between the feeder 1311 and the radiator 121, so that the antenna element 12 is formed as a center-fed dipole.

Still refer to FIG. 4 to FIG. 6. In an implementation, a cross-sectional area of the second connection part 12112 is different from a cross-sectional area of the feeder 1311. Specifically, the second connection part 12112 can be made thicker, and the feeder 1311 can be made thinner; or the second connection part 12112 can be made thinner, and the feeder 1311 can be made thicker. In a specific embodiment, if the second connection part 12112 and the feeder 1311 have a same thickness, a width of the second connection part 12112 may be different from a width of the feeder 1311. Similarly, a cross-sectional area of the fourth connection part 12142 is different from a cross-sectional area of the feeder 1311. Specifically, the fourth connection part 12142 can be made thicker, and the feeder 1311 can be made thinner; or the fourth connection part 12142 can be made thinner, and the feeder 1311 can be made thicker. In a specific embodiment, if the fourth connection part 12142 and the feeder 1311 have a same thickness, a width of the fourth connection part 12142 may be different from a width of the feeder 1311. In this solution, the transmission lines in the feed path have changes in thickness, and impedance matching may be performed, to improve the bandwidth. In addition, the transmission line (the second connection part and the fourth connection part) connected to the feeder 1311 is thick, which can increase inductance and enable a resonance point of the radiator 121 to move toward a high frequency.

In addition, in another possible implementation, the cross-sectional area of the second connection part 12112 is different from a cross-sectional area of the first connection part 12111. Specifically, the second connection part 12112 can be made thicker, and the first connection part 12111 can be made thinner; or the second connection part 12112 can be made thinner, and the first connection part 12111 can be made thicker. In a specific embodiment, if the second connection part 12112 and the first connection part 12111 have a same thickness, the width of the second connection part 12112 may be different from a width of the first connection part 12111. Similarly, the cross-sectional area of the fourth connection part 12142 is different from a cross-sectional area of the third connection part 12141. Specifically, the fourth connection part 12142 can be made thicker, and the third connection part 12141 can be made thinner; or the fourth connection part 12142 can be made thinner, and the third connection part 12141 can be made thicker. In a specific embodiment, if the fourth connection part 12142 and the third connection part 12141 have a same thickness, the width of the fourth connection part 12142 may be different from a width of the third connection part 12141. Similarly, the first connection part 12111 and the second connection part 12112 of the first transmission line 1211 may also be considered as a part of the feed path, and the third connection part 12141 and the fourth connection part 12142 of the second transmission line 1214 may also be considered as a part of the feed path. This also means that the transmission lines in the feed path have changes in thickness, and impedance matching may be performed, to improve the bandwidth.

In a possible implementation, the cross-sectional area of the second connection part 12112 is different from the cross-sectional area of the feeder 1311, and the cross-sectional area of the second connection part 12112 is different from the cross-sectional area of the first connection part 12111. For example, the second connection part 12112 can be made thicker relative to both sides. Similarly, the cross-sectional area of the fourth connection part 12142 is different from the cross-sectional area of the feeder 1311, and the cross-sectional area of the fourth connection part 12142 is different from the cross-sectional area of the third connection part 12141. For example, the fourth connection part 12142 can be made thicker relative to both sides. In this solution, the transmission lines in the feed path have rich changes in thickness, which is beneficial to improving an impedance matching effect and improving the bandwidth.

Still refer to FIG. 5 and FIG. 6. In a specific embodiment, a cross-sectional area of the first radiation arm 1212 is different from a cross-sectional area of the second radiation arm 1213. In embodiments shown in FIG. 5 and FIG. 6, the second radiation arm 1213 is thicker than the first radiation arm 1212. In this solution, different radiation arms of the radiator have changes in thickness, which is also beneficial for impedance matching and bandwidth improvement.

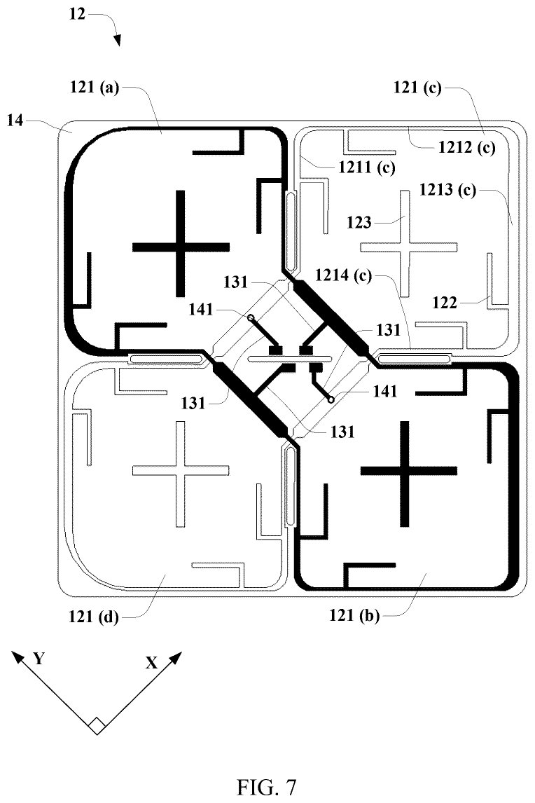

FIG. 7 is another diagram of a structure of an antenna element of an antenna according to an embodiment of this application. As shown in FIG. 7, in a possible embodiment, stubs 122 may be further disposed on the antenna element 12. Specifically, the first radiation arm 1212, the second radiation arm 1213, the first transmission line 1211, and the second transmission line 1214 of the radiator 121 each may be connected to a stub 122. A high-frequency decoupling effect can be implemented. Especially, when an antenna includes antenna elements 12 of a plurality of frequency bands, the stubs 122 are also disposed, which can reduce impact of the antenna element on the antenna elements of higher frequency bands, thereby facilitating multi-band cooperative work of the antenna and reducing an aperture occupied by the antenna. The stubs 122 of the first radiator 121(a) and the second radiator 121(b) are symmetrically arranged in a first direction X, and the stubs 122 of the third radiator 121(c) and the fourth radiator 121(d) are symmetrically arranged in a second direction Y. Therefore, impact of the stubs on directions of radiation signals of the antenna element 12 can be reduced.

In a specific implementation, the stub 122 may be an L-shaped stub, a cross-shaped stub, or a ±-shaped stub. This is not limited in this application.

In addition, still refer to FIG. 7. An additional stub 123 may be further disposed in the radiator 121, and the additional stub 123 is located only inside the radiator 121, and is not electrically connected to any radiation arm or transmission line. The additional stubs 123 of the first radiator 121(a) and the second radiator 121(b) are symmetrical with respect to the first direction X, and the additional stubs 123 of the third radiator 121(c) and the fourth radiator 121(d) are symmetrical with respect to the second direction Y. Similarly, this solution can implement a high-frequency decoupling effect. Especially, when an antenna includes antenna elements 12 of a plurality of frequency bands, the stubs 122 are also disposed, which can reduce impact of the antenna element 12 on the antenna elements 12 of higher frequency bands, thereby facilitating multi-band cooperative work of the antenna and reducing an aperture occupied by the antenna.

The additional stub may be a symmetric stub, so that a polarization direction of the antenna element is stable and accurate.

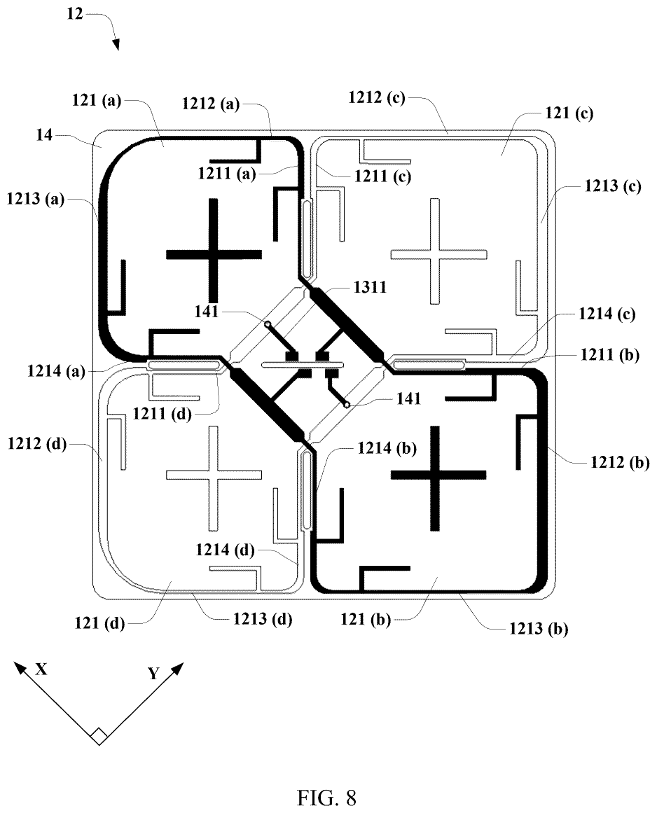

FIG. 8 is another diagram of a structure of an antenna element according to an embodiment of this application. As shown in FIG. 8, in another possible embodiment, a length of the first transmission line 1211(a) of the first radiator 121(a) is not equal to a length of the first transmission line 1211(b) of the second radiator 121(b), and a length of the first transmission line 1211(c) of the third radiator 121(c) is not equal to a length of the first transmission line 1211(d) of the fourth radiator 121(d). In this embodiment, lengths of two transmission lines that are connected in parallel and that are connected to a same feed network are different, which allows the radiator 121 to introduce a preset phase, and a beam of the radiator deflects to one side of a transmission line with a longer length, to adapt to a beam deflection requirement in a harsh reflection panel environment. Compared with a single dipole, the radiator in this application has a more significant preset phase effect. In this solution, a length of a transmission line of the radiator 121 may be designed based on the beam deflection requirement. An adjustment manner is simple, and better horizontal beam deflection advantages can be achieved in an asymmetric environment.

In a further embodiment, a length of the second transmission line 1214(a) of the first radiator 121(a) may be different from a length of the second transmission line 1214(b) of the second radiator 121(b), and a length of the second transmission line 1214(c) of the third radiator 121(c) may be different from a length of the second transmission line 1214(d) of the fourth radiator 121(d).

In the embodiment shown in FIG. 8, the first radiation arm 1212(a) of the first radiator 121(a), the second radiation arm 1213(b) of the second radiator 121(b), the first radiation arm 1212(c) of the third radiator 121(c), and the second radiation arm 1213(d) of the fourth radiator 121(d) are parallel, a length of the first radiation arm 1212(a) of the first radiator 121(a) is not equal to a length of the second radiation arm 1213(b) of the second radiator 121(b), and a length of the first radiation arm 1212(c) of the third radiator 121(c) is not equal to a length of the second radiation arm 1213(d) of the fourth radiator 121(d). In this solution, each radiator 121 is approximately rectangular.

In a specific embodiment, a first length difference exists between the length of the first transmission line 1211(a) of the first radiator 121(a) and the length of the first transmission line 1211(b) of the second radiator 121(b), and a second length difference exists between the length of the first transmission line 1211(c) of the third radiator 121(c) and the length of the first transmission line 1211(d) of the fourth radiator 121(d). The first length difference and the second length difference may be equal, so that a structure of the entire antenna element 12 is regular, which is beneficial to reducing space occupied by the antenna element 12 and reducing the aperture occupied by the antenna. In addition, radiation signals of the antenna in the two polarization directions may be made the same or close to each other.

In this application, the first length difference and the second length difference may be designed and selected based on an actual beam deflection requirement. In a specific embodiment, the first length difference may be 7 mm, and the second length difference may also be 7 mm.

When the antenna is specifically prepared, the feed structure 131 and the antenna element 12 may be formed on a same dielectric plate 14. Specifically, the first radiator 121(a) and the second radiator 121(b) may be disposed on a same layer of the dielectric plate 14, for example, a first layer, and the third radiator 121(c) and the fourth radiator 121(d) may be disposed on another layer of the dielectric plate 14, for example, a second layer. For example, the first radiator 121(a) and the second radiator 121(b) may be disposed on one side surface of the dielectric plate 14, and the third radiator 121(c) and the fourth radiator 121(d) may be disposed on the other side surface of the dielectric plate 14. The antenna element 12 in this solution is formed into a planar structure, and is easy to manufacture. In addition, in this solution, the radiators 121 in the two polarization directions are staggered in height from each other, and are specifically located at different layers of the dielectric plate 14, so that the radiators 121 in the two polarization directions are insulated, to implement dual polarization. In addition, a distance between radiators 121 with different polarization directions is close, which can form coupling, thereby facilitating implementation of a broadband characteristic of the antenna element 12.

When the feed structure 131 is specifically formed, the overall feed structure 131 and the radiator 121 in one polarization direction may be located at a same layer, and the radiator 121 in the other polarization direction is connected to the feed structure 131 through a conductive via 141. For example, in the embodiment shown in FIG. 4, the feed structure 131, the first radiator 121(a), and the second radiator 121(b) are disposed on the first layer of the dielectric plate 14, and the third radiator 121(c) and the fourth radiator 121(d) are disposed on the second layer of the dielectric plate 14. In this case, the third radiator 121(c) and the fourth radiator 121(d) are connected to the feed structure 131 through the conductive via 141. In another embodiment, radiators and feed structures at different layers may be connected in a coupling manner.

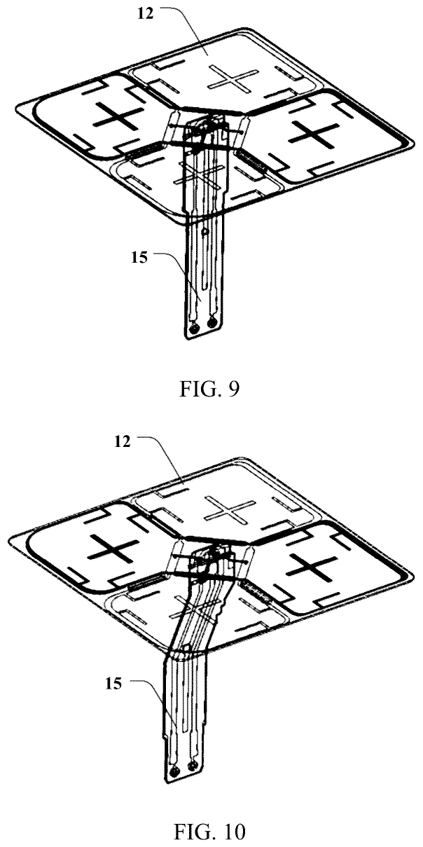

The antenna in embodiments of this application may support different types of feeding manners. The antenna may be directly fed in a coaxial manner, or may be fed by using a balun, which is specifically designed and selected according to requirements. When the antenna is fed by using the balun, the balun may be a straight balun, or the balun may be a cross-shaped balun. FIG. 9 is a diagram of feeding of an antenna element according to an embodiment of this application. FIG. 10 is another diagram of feeding of an antenna element according to an embodiment of this application. FIG. 9 and FIG. 10 are diagrams of a straight balun 15 for feeding. FIG. 9 is a diagram of a straight balun used as a feed structure, and FIG. 10 is a diagram of a slanted balun used as a feed structure. A same antenna may include both the straight balun and the slanted balun. Through flexible configuration of the straight balun and the slanted balun, an array spacing can be effectively extended in compact space.

It is clear that a person skilled in the art can make various modifications and variations to this application without departing from the scope of this application. In this case, if the modifications and variations of this application fall within the scope of the claims of this application and equivalent technologies thereof, this application is also intended to include the modifications and variations.

1. An antenna element, comprising four radiators and four feed structures, wherein the feed structure is connected to the radiator and is configured to feed the radiator;
the radiator comprises a first transmission line, a first radiation arm, a second radiation arm, and a second transmission line that are sequentially connected, and the first transmission line and the second transmission line are respectively connected to the feed structures;
the four radiators are respectively a first radiator, a second radiator, a third radiator, and a fourth radiator, wherein the first radiator and the second radiator radiate signals in a first polarization direction, the third radiator and the fourth radiator radiate signals in a second polarization direction, and the first polarization direction intersects with the second polarization direction; and
the feed structure is a one-to-two feed structure, the feed structures comprise a first feed structure, a second feed structure, a third feed structure, and a fourth feed structure, wherein the first transmission line of the first radiator and the first transmission line of the second radiator are connected in parallel and connected to the first feed structure, the second transmission line of the first radiator and the second transmission line of the second radiator are connected in parallel and connected to the second feed structure, the first transmission line of the third radiator and the first transmission line of the fourth radiator are connected in parallel and connected to the third feed structure, and the second transmission line of the third radiator and the second transmission line of the fourth radiator are connected in parallel and connected to the fourth feed structure.

2. The antenna element according to claim 1, wherein a length of the first transmission line of the first radiator is not equal to a length of the first transmission line of the second radiator, and a length of the first transmission line of the third radiator is not equal to a length of the first transmission line of the fourth radiator.

3. The antenna element according to claim 1, wherein the first polarization direction is perpendicular to the second polarization direction.

4. The antenna element according to claim 1, wherein the first transmission line of the radiator is perpendicular to the first radiation arm, the first radiation arm is perpendicular to the second radiation arm, and the second radiation arm is perpendicular to the second transmission line.

5. The antenna element according to claim 1, wherein the feed structure comprises a feeder, the first transmission line comprises a first connection part and a second connection part connected to each other, the second connection part is connected to the feeder, and a cross-sectional area of the second connection part is different from a cross-sectional area of the feeder; and the second transmission line comprises a third connection part and a fourth connection part connected to each other, the fourth connection part is connected to the feeder, and a cross-sectional area of the fourth connection part is different from a cross-sectional area of the feeder.

6. The antenna element according to claim 5, wherein the cross-sectional area of the second connection part is different from a cross-sectional area of the first connection part, and the cross-sectional area of the fourth connection part is different from a cross-sectional area of the third connection part.

7. The antenna element according to claim 1, wherein a cross-sectional area of the first radiation arm is different from a cross-sectional area of the second radiation arm.

8. The antenna element according to claim 1, wherein the first radiation arm, the second radiation arm, the first transmission line, and the second transmission line of the radiator each are connected to a stub.

9. The antenna element according to claim 8, wherein the stubs comprise at least one of an L-shaped stub, a cross-shaped stub, or a ±-shaped stub.

10. The antenna element according to claim 1, wherein an additional stub is disposed inside the radiator, the additional stubs of a first radiator and the second radiator are symmetric in the first direction, and the additional stubs of the third radiator and the fourth radiator are symmetric in a second direction.

11. The antenna element according to claim 10, wherein the additional stub is a symmetric stub.

12. The antenna element according to claim 1, wherein the feed structure and the antenna element are formed on a same dielectric plate.

13. An antenna, comprising a feed network and a plurality of antenna elements, wherein the feed structure is connected to the feed network, wherein the antenna element comprises four radiators and four feed structures, wherein the feed structure is connected to the radiator and is configured to feed the radiator;
the radiator comprises a first transmission line, a first radiation arm, a second radiation arm, and a second transmission line that are sequentially connected, and the first transmission line and the second transmission line are respectively connected to the feed structures;
the four radiators are respectively a first radiator, a second radiator, a third radiator, and a fourth radiator, wherein the first radiator and the second radiator radiate signals in a first polarization direction, the third radiator and the fourth radiator radiate signals in a second polarization direction, and the first polarization direction intersects with the second polarization direction; and
the feed structure is a one-to-two feed structure, the feed structures comprise a first feed structure, a second feed structure, a third feed structure, and a fourth feed structure, wherein the first transmission line of the first radiator and the first transmission line of the second radiator are connected in parallel and connected to the first feed structure, the second transmission line of the first radiator and the second transmission line of the second radiator are connected in parallel and connected to the second feed structure, the first transmission line of the third radiator and the first transmission line of the fourth radiator are connected in parallel and connected to the third feed structure, and the second transmission line of the third radiator and the second transmission line of the fourth radiator are connected in parallel and connected to the fourth feed structure.

14. The antenna according to claim 13, wherein a length of the first transmission line of the first radiator is not equal to a length of the first transmission line of the second radiator, and a length of the first transmission line of the third radiator is not equal to a length of the first transmission line of the fourth radiator.

15. The antenna according to claim 13, wherein the first polarization direction is perpendicular to the second polarization direction.

16. The antenna according to claim 13, wherein the first transmission line of the radiator is perpendicular to the first radiation arm, the first radiation arm is perpendicular to the second radiation arm, and the second radiation arm is perpendicular to the second transmission line.

17. The antenna according to claim 13, wherein the feed structure comprises a feeder, the first transmission line comprises a first connection part and a second connection part connected to each other, the second connection part is connected to the feeder, and a cross-sectional area of the second connection part is different from a cross-sectional area of the feeder; and the second transmission line comprises a third connection part and a fourth connection part connected to each other, the fourth connection part is connected to the feeder, and a cross-sectional area of the fourth connection part is different from a cross-sectional area of the feeder.

18. The antenna according to claim 17, wherein the cross-sectional area of the second connection part is different from a cross-sectional area of the first connection part, and the cross-sectional area of the fourth connection part is different from a cross-sectional area of the third connection part.

19. The antenna according to claim 13, wherein a cross-sectional area of the first radiation arm is different from a cross-sectional area of the second radiation arm.

20. The antenna according to claim 13, wherein the first radiation arm, the second radiation arm, the first transmission line, and the second transmission line of the radiator each are connected to a stub.
